(19) United States
(12) Patent Application Publication
(10) Pub. No.: US 2012/0009857 A1
(43) Pub. Date: Jan. 12, 2012

(54) Meat Scoring and Cutting Implement

(75) Inventors: Jeffrey Allen Harden, Dunlap, TN (US); Alan Scot Peppel, Charlton, MA (US)

(73) Assignee: Dexter-Russell, Inc., Southbridge, MA (US)

(21) Appl. No.: 12/831,514

(22) Filed: Jul. 7, 2010

(51) Int. Cl. A22C 17/00; B26B 9/02

(52) U.S. Cl. 452/156; 452/149; 30/356

(57) ABSTRACT

A meat scoring or cutting implement having a thin, elongated blade lying along a blade longitudinal axis that is curved along its length, to define a bend or curve in the blade. The blade defines opposing side surfaces that meet at an acute angle to thereby define a cutting edge along at least a portion of the length of the blade. The blade further defines a tip at one end, the tip at least in part defined by an end wall that lies at an obtuse angle to the cutting edge.

### FIELD

This invention relates to a blade for scoring and cutting meat.

### BACKGROUND

Knives are used to score and cut meat. Bones are typically separated from meat with a semi-flex boning knife. Proper use of boning knives requires great skill and experience. Also, in order for the cuts to be consistent from one portion to the next, the operator must use the knife in exactly the same manner, including its depth and angle of insertion, and the cutting motion. As a practical matter it is not possible for precise repetition, particularly when the blade needs to be maintained in a particular orientation and angle as it is drawn through the carcass. This leads to inconsistency from cut-to-cut, which can mean that too much or too little meat is left on the bone. This can lower profits or even lead to rejection of the cut by the customer. Also, holding a knife in this manner and pushing or pulling the knife can create great strain on the operator, which can lead to fatigue or even repetitive motion-type injuries.

### SUMMARY

The meat scoring and cutting implement can lead to increased yield, proper proportioning of the amount of meat left on the bone and thus a better profit margin, and greater meat cutter productivity. The implement may also lead to better ergonomics and thus potentially fewer repetitive motion-type injuries.

Featured in one embodiment is a meat scoring and cutting implement comprising a thin, elongated blade lying along a blade longitudinal axis that is curved along its length, to define a bend or curve in the blade. The blade defines opposing side surfaces that meet at an acute angle to thereby define a cutting edge along at least a portion of the length of the blade. The blade further defines a tip at one end, the tip at least in part defined by an end wall that lies at an obtuse angle to the cutting edge. The end wall of the blade may be straight, and the obtuse angle may be about 100°.

The blade may define two cutting edges. The tip may be defined by two straight end walls, wherein each end wall lies at an obtuse angle to one of the cutting edges. The cutting edges may be essentially parallel. The meat scoring or cutting implement may further include a handle that carries the blade such that a portion of the blade projects from the handle. The cutting edges may be located along essentially all of the portion of the blade that projects from the handle. The blade may define a generally diamond-shaped cross-section.

The cutting edge may be essentially straight. The blade may define a single bend along its length. The bend may be located between the ends of the blade. The blade may be essentially straight from each end of the bend to the closest end of the blade. The bend may be essentially continuous. The bend may have a radius of curvature of less than one inch.

Also featured is a meat scoring or cutting implement comprising a thin, elongated blade lying along a blade longitudinal axis that is curved along its length, to define a single essentially continuous bend in the blade, wherein the bend is located between the ends of the blade and the blade is essentially straight from each end of the bend to the closest end of the blade. The blade may define a generally diamond-shaped cross-section, with opposing side surfaces that meet at shallow acute angles at both the top and bottom of the blade, to thereby define two cutting edges along at least a portion of the length of both the top and bottom of the blade. The blade may further define a tip at one end, the tip defined by two straight end walls, wherein each end wall lies at an angle of about 100° to one of the cutting edges.

The meat scoring or cutting implement may further comprise a handle that carries the blade such that a portion of the blade projects from the handle, the portion carrying the cutting edges. The cutting edges are preferably each essentially straight. The cutting edges may be essentially parallel. The blade may extend from the handle at least about two and one-half inches, and the bend may be such that the tip of the blade is located at least about one inch from the longitudinal axis of the handle.

Also featured is a method of scoring or cutting a pork belly proximate the ribs, to facilitate removal of the ribs along with a controlled amount of meat. The method comprises providing a thin, elongated blade lying along a blade longitudinal axis that is curved along its length, to define a bend in the blade. The blade defines opposing side surfaces that meet at an acute angle to thereby define a cutting edge along at least a portion of the length of the blade, and a tip at one end, the tip at least in part defined by an end wall that lies at an obtuse angle to the cutting edge. The method includes positioning the blade such that an end wall of its tip lies on the ribs to position the cutting edge above the ribs with the bend following the curve of the ribs. The blade is moved along the ribs such that the cutting edge cuts the meat proximate the ribs, to score the carcass proximate the ribs so that the ribs along with an amount of meat proximate the ribs can be removed from the belly. The method may further comprise providing an automated blade positioning and movement system. The automated blade positioning and movement system may comprise a blade positioning and moving device controlled by a controller that is responsive to a camera.

### BRIEF DESCRIPTION OF THE DRAWINGS

FIG. 1A is a top view of a meat scoring and cutting implement;

FIG. 1B is a side view of the implement shown in FIG. 1A;

FIG. 2A is a top view of a knife that includes the implement shown in FIGS. 1A and 1B;

FIG. 2B is a side view of the knife of FIG. 2A;

FIG. 2C is a cross-sectional view taken along line A-A of FIG. 2A;

FIG. 3 is a cross-sectional view showing the implement in use scoring underneath the ribs as part of the process of separating spare ribs from a pork belly; and

FIG. 4 is a top view of the implement in use scoring underneath the ribs as part of the process of separating spare ribs from a pork belly, also illustrating an automated scoring/cutting process.

### DETAILED DESCRIPTION

This invention may be accomplished in a meat scoring or cutting implement having a thin, elongated blade lying along a blade longitudinal axis that is curved along its length, such that there is a bend or curve in the blade. The blade defines opposing side surfaces that meet at a shallow acute angle to thereby define a cutting edge along at least a portion of the length of the blade. The blade further defines a wide tip at one end, the tip at least in part defined by an end wall that lies at an obtuse angle to the cutting edge. The blade may be generally rectangular rather than being tapered from the heel to the pint or tip, such that its height is the same at the heel and the tip end, and its spine is parallel to its edges. In one embodiment the blade has two parallel edges, with a thickened medial portion that provides the structural stability in place of the traditional spine of a single-edged blade.

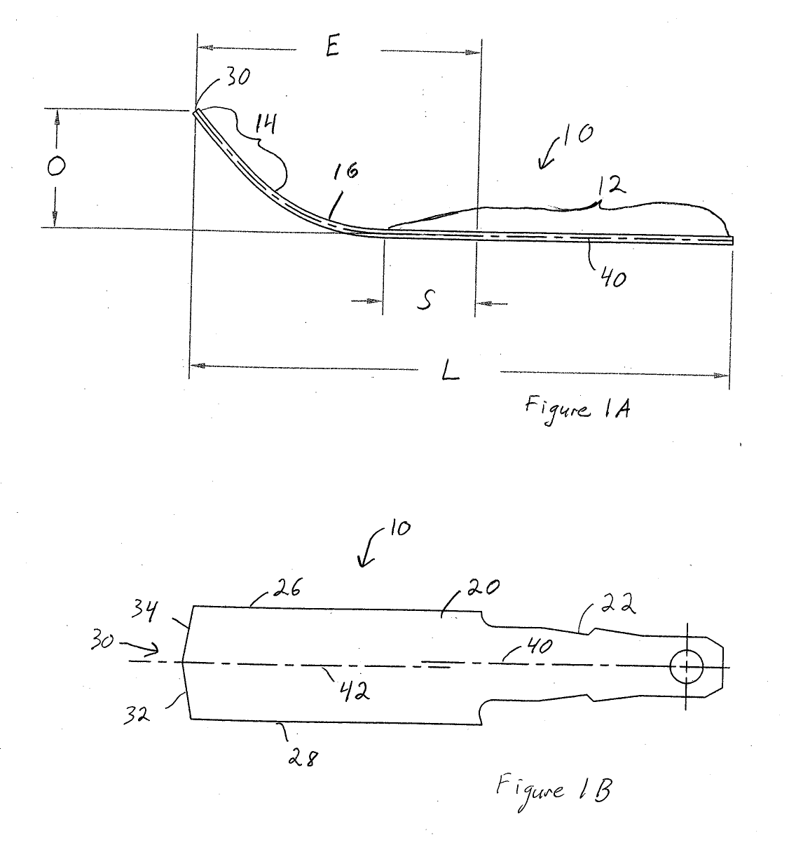

FIGS. 1A and 1B are top and side views, respectively, of one embodiment of a meat scoring and cutting implement. Metal blade 10 is a thin, elongated blade lying along blade longitudinal axis 40 that is curved along its length, to define a bend or curve in blade 10. Blade 10 comprises proximal straight portion 12, curved portion 16 and far straight portion 14 that ends with tip 30.

Blade 10 defines upper cutting edge 26 that is essentially parallel to lower cutting edge 28. Tip 30 is defined by lower end wall 32 and upper end wall 34. Each of these end walls lies at an obtuse angle to the cutting edge that it intersects. In one non-limiting embodiment of the invention, this angle (α) is about 100°. Stated another way, the angle of the wall relative to the normal to the blade edges (line “N”), shown as angle β, is about 10°.

Blade 10 in this embodiment defines a cutting portion 20 and an anchoring or gripping portion 22. Blade 10 is preferably crafted from an integral thin metal sheet that is created, treated, ground and bent to the form shown in the drawings. Each of these blade-making operations is well known to those skilled in the field so is not further detailed herein. One result of these operations is that blade 10 can take and hold a bend. Further, if desired this bend can be altered after blade or knife fabrication has been completed, to alter the cutting or scoring characteristics of the blade.

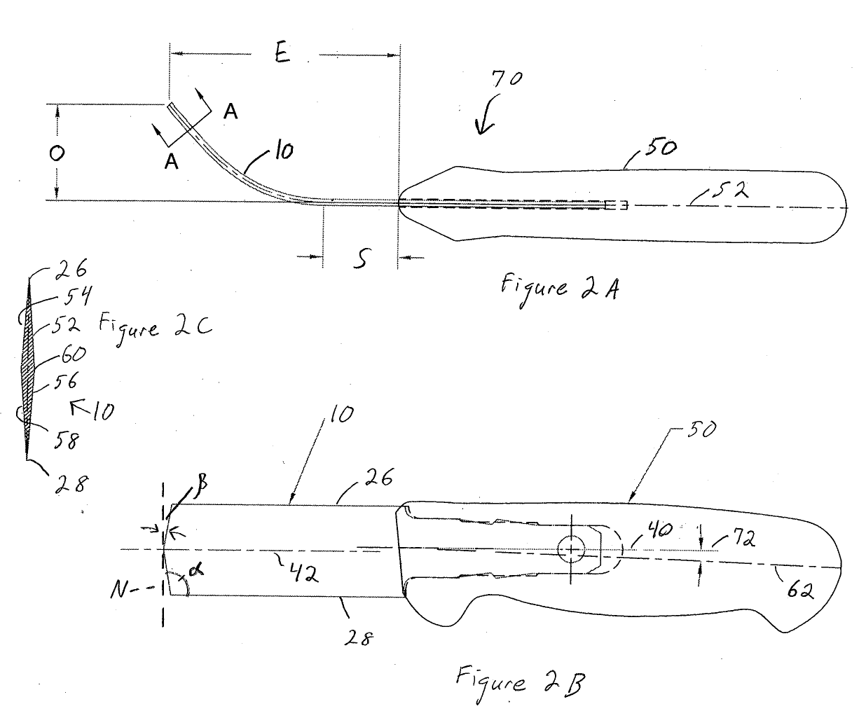

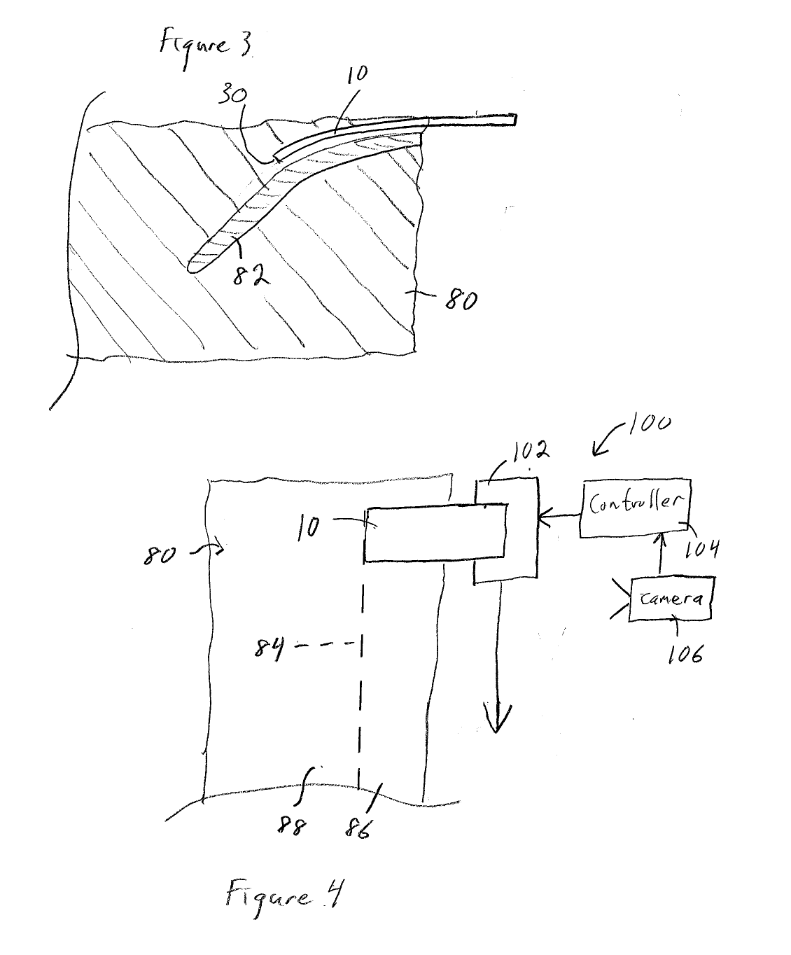

Meat scoring and cutting implement 70, FIGS. 2A and 2B, is a knife comprising handle 50 into which anchoring portion 22 of blade 10 is inserted and held. Such anchoring of a blade into a handle is known in the art. Preferably, blade longitudinal axis 40 is located at a small angle 72 from handle longitudinal axis 62. This angle may be about 2°. Such angling of a blade relative to a handle in order to cant the blade slightly with respect to the handle is known in the art. Central longitudinal axis 42 of cutting portion 20 in this embodiment is slightly the offset below longitudinal axis 40. In one embodiment, this offset is approximately 0.05 inches. A slight offset such as this is also known in the art.

Blade cutting portion 20 preferably has a generally diamond-shaped cross section as shown in FIG. 2C. This is accomplished by forming or grinding the cutting portion such that the flat side surfaces meet at a very shallow acute angle to thereby define the one or two cutting edges along at least a portion of the length of the blade. Lower side surfaces 56 and 58 taper toward one another from center 60. Upper side surfaces 52 and 54 likewise taper toward one another from center 60. This forms lower cutting edge 28 and upper cutting edge 26. The overall thickness of the blade at central portion 60 is about 0.075 inches. This provides some rigidity to the blade that is needed because the upper edge where the spine would be in a single-edged blade is in this embodiment instead a second edge. Note that the implement could have only a single edge, in which case the spine could be present, in which case the blade would not need to be generally rectangular shaped as it is in the preferred embodiment.

In one specific embodiment, the dimensions of the blade are as follows: overall length “L” (from end to end along a linear axis that is coincident with axis 40 along portion 12) about 5.099 inches. Offset “O” of tip 30 from this straight line, about 1.110 inches. Extending length “E” of the blade extension from the handle, about 2.688 inches. Length “S” of proximal straight portion 12 that extends from handle 50, about 0.875 inches. Radius of curvature of essentially continuous bend 16, about 0.75 inches. Height from one cutting edge to the other, about 1.063 inches.

The meat scoring and cutting implement does not need to have two cutting edges. The two edges allow the implement to score or cut in two directions, making its use more efficient than would be the case if there was only a single cutting edge.

One use of the meat scoring and cutting implement is to score or cut a pork carcass. One way is to score the belly along the underside of the ribs, to a depth of about 1.5 inches. This score line can then be used as a guide to the separation of the spare ribs from the belly. The implement facilitates removal of the ribs along with a controlled amount of meat. See FIGS. 3 and 4. To use the meat scoring and cutting implement for this purpose, the blade is positioned such that the concavely-curved side lies just above the rib 82, with the bend following the curve of the ribs. The tip 32 can be placed on the ribs such that the angled surface farthest from the edge being used to cut lies on the ribs. In other words, if edge 28 is being used to cut the meat then end wall 34 is placed on the ribs. This raises edge 28 up off the bone surface by an amount defined by the angle and the length of the end wall that extends into the meat. The implement is then pushed or pulled in a straight line away from or towards the body, respectively. As a result, the scoring leaves a defined amount of meat (typically one-quarter or three-eighths inch) on the bone.

The construction provides a consistent scoring cut that accomplishes more consistency in the end product. Also, the curve of the blade and the angled tip allow the scoring operation to be performed by an operator with little or no experience in spare-rib removal, as all that is necessary is for the blade to be plunged into the belly 80 beginning at the flank end (this position shown in FIG. 4), the blade positioned such that an end wall lies on the ribs, and the implement pulled or pushed in a straight line (along line 84) to the end of the rib area. This leaves a score line about 1.5″ deep along line 84. A traditional boning knife can then be used to complete the cut along this score line, thus separating the spare ribs 86 from the remaining portion 88.

The meat scoring and cutting implement can also be used in a more automated operation. The blade can be coupled to a machine 102 that accomplishes the cutting motion. Since the cutting motion can be a simple linear motion, the blade lends itself to such automation. The automation can be further enhanced by use of an optional automated machine vision and blade control system 100 that can be used to properly position the blade with respect to the carcass at the beginning of the operation, and then pull or push the blade through the meat.

System 100 includes camera 106 that captures an image of the carcass, and of the implement as it is being positioned and moved, and controller 104 that positions and moves the implement via machine 102. Machine vision systems that position and move one part relative to another are known, particularly in the field of robotics. Such systems can be adapted for use herein. The linear blade movement after proper positioning of the blade can potentially be accomplished without the need for further machine vision input or control other than straight-line motion of a desired distance.

Other implementations are within the scope of the following claims.

1. A meat scoring and cutting implement, comprising:
a thin, elongated blade lying along a blade longitudinal axis that is curved along its length, to define a bend or curve in the blade;
wherein the blade defines opposing side surfaces that meet at an acute angle to thereby define a cutting edge along at least a portion of the length of the blade; and
wherein the blade further defines a tip at one end, the tip at least in part defined by an end wall that lies at an obtuse angle to the cutting edge.

2. The meat scoring or cutting implement of claim 1 wherein the blade defines two cutting edges.

3. The meat scoring or cutting implement of claim 2 wherein the tip is defined by two straight end walls, wherein each end wall lies at an obtuse angle to one of the cutting edges.

4. The meat scoring or cutting implement of claim 2 wherein the cutting edges are essentially parallel.

5. The meat scoring or cutting implement of claim 4 further comprising a handle that carries the blade such that a portion of the blade projects from the handle.

6. The meat scoring or cutting implement of claim 5 wherein the cutting edges are located along essentially all of the portion of the blade that projects from the handle.

7. The meat scoring or cutting implement of claim 4 wherein the blade defines a generally diamond-shaped cross-section.

8. The meat scoring or cutting implement of claim 1 wherein the cutting edge is essentially straight.

9. The meat scoring or cutting implement of claim 1 wherein the blade defines a single bend along its length.

10. The meat scoring or cutting implement of claim 9 wherein the bend is located between the ends of the blade.

11. The meat scoring or cutting implement of claim 10 wherein the blade is essentially straight from each end of the bend to the closest end of the blade.

12. The meat scoring or cutting implement of claim 11 wherein the bend is essentially continuous.

13. The meat scoring or cutting implement of claim 12 wherein the bend has a radius of curvature of less than one inch.

14. The meat scoring or cutting implement of claim 1 wherein the end wall is straight, and the obtuse angle is about 100°.

15. A meat scoring or cutting implement, comprising:
a thin, elongated blade lying along a blade longitudinal axis that is curved along its length, to define a single essentially continuous bend in the blade, wherein the bend is located between the ends of the blade and the blade is essentially straight from each end of the bend to the closest end of the blade;
wherein the blade defines a generally diamond-shaped cross-section, with opposing side surfaces that meet at shallow acute angles at both the top and bottom of the blade, to thereby define two cutting edges along at least a portion of the length of both the top and bottom of the blade; and
wherein the blade further defines a tip at one end, the tip defined by two straight end walls, wherein each end wall lies at an angle of about 100° to one of the cutting edges.

16. The meat scoring or cutting implement of claim 15 further comprising a handle that carries the blade such that a portion of the blade projects from the handle, the portion carrying the cutting edges.

17. The meat scoring or cutting implement of claim 16 wherein the cutting edges are each essentially straight.

18. The meat scoring or cutting implement of claim 17 wherein the cutting edges are essentially parallel.

19. The meat scoring or cutting implement of claim 18 wherein the blade extends from the handle at least about two and one-half inches, and the bend is such that the tip of the blade is located at least about one inch from the longitudinal axis of the handle.

20. A method of scoring or cutting a pork belly proximate the ribs, to facilitate removal of the ribs along with a controlled amount of meat, comprising:
providing a thin, elongated blade lying along a blade longitudinal axis that is curved along its length, to define a bend in the blade, the blade defining opposing side surfaces that meet at an acute angle to thereby define a cutting edge along at least a portion of the length of the blade, the blade further defining a tip at one end, the tip at least in part defined by an end wall that lies at an obtuse angle to the cutting edge;
positioning the blade such that an end wall of its tip lies on the ribs to position the edge above the ribs, with the bend following the curve of the ribs; and
drawing the blade along the ribs such that the cutting edge cuts the meat proximate the ribs, to score the carcass proximate the ribs so that the ribs along with an amount of meat proximate the ribs can be removed from the belly.

21. The method of claim 20 further comprising providing an automated blade positioning and movement system.

22. The method of claim 21 wherein the automated blade positioning and movement system comprises a blade positioning and moving device controlled by a controller that is responsive to a camera.
